(19) United States
(12) Patent Application Publication
(10) Pub. No.: US 2016/0017576 A1
(43) Pub. Date: Jan. 21, 2016

(54) Spigot Extender for a Garden Hose

(71) Applicant: Travis Simmons, Hot Springs, AR (US)

(72) Inventor: Travis Simmons, Hot Springs, AR (US)

(21) Appl. No.: 14/682,075

(22) Filed: Apr. 8, 2015

Related U.S. Application Data
(60) Provisional application No. 62/026,100, filed on Jul. 18, 2014.

(51) Int. Cl. E03B 7/09; F16K 31/60

(52) U.S. Cl. CPC E03B 7/09; F16K 31/60

(57) ABSTRACT

A spigot extender for a garden hose replaces a standard water spigot, and is comprised of a horizontal pipe with an enlarged circular handle at the front end, and threads for attachment to a water supply pipe at the rear end. Extending downward from the forward portion of the horizontal pipe beneath the handle, a descending pipe is provided which is preferably four to six inches in length. At the lower end of the descending pipe, threads are provided for attachment of a garden hose or other device. By replacing the existing spigot, the device of the invention achieves improved utility over standard spigots and temporary extension devices by providing both a valve control handle and an access pipe that are distinctly elongated a significantly distal to the wall in the location of installation.

### CROSS-REFERENCE TO RELATED APPLICATIONS

This application claims the benefit of U.S. Provisional Application No. 62/026,100, filed Jul. 18, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to lawn and garden tools and accessories, and in particular to a spigot extender for a garden hose. On the exterior side or rear wall of most homes, a water spigot is provided and it has been very useful for watering the lawn and garden, or washing the family car. Unfortunately, connecting a garden hose directly to the spigot presents a risk of injury, and it is sometimes difficult to get a firm grip on the hose to create a tight seal. This is particularly true if the user is elderly, disabled, or very young, or is compelled to use the spigot under less than ideal conditions, such as darkness or rain. A spigot extender for a garden hose, which attaches to the spigot and provides an extra length of pipe such that the user can easily get a firm grip, would resolve this problem.

### SUMMARY OF THE INVENTION

Accordingly, the invention is directed to a spigot extender for a garden hose. The invention is intended to replace a standard water spigot, and is comprised of a horizontal pipe with an enlarged circular handle at the front end, and threads for attachment to a water supply pipe at the rear end. Extending downward from the forward portion of the horizontal pipe beneath the handle, a descending pipe is provided which is preferably four to six inches in length. At the lower end of the descending pipe, threads are provided for attachment of a garden hose or other device.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a side view of the first exemplary embodiment, displaying the extender 10, the horizontal pipe 11, the horizontal pipe first end 11A, the horizontal pipe second end 11B, the handle 12, the threads 13, and the descending pipe 14, the descending pipe lower end 14A, the descending pipe upper end 14B, the shield 15, and the valve 16.

FIG. 2 is a side perspective view of the first exemplary embodiment, displaying the extender 10, the horizontal pipe 11, the handle 12, the threads 13, and the descending pipe 14.

FIG. 3 is a front view of the first exemplary embodiment, displaying the extender 10, the handle 12, the threads 13, and the descending pipe 14.

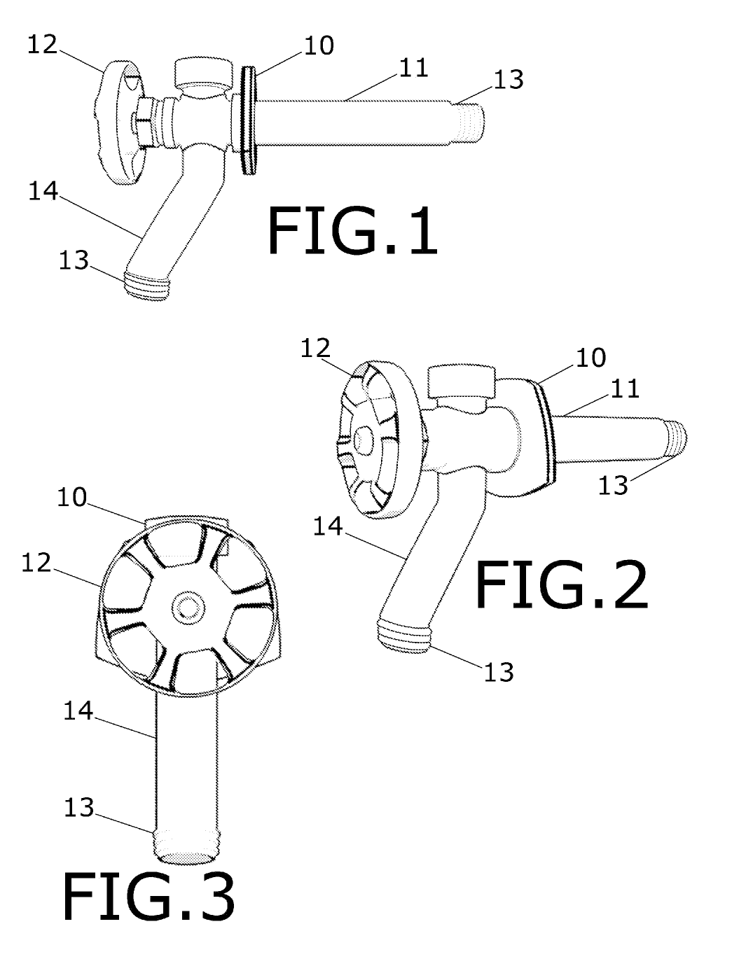

### DETAILED DESCRIPTION OF THE INVENTION

Referring now to the invention in more detail, the invention is directed to spigot extender 10 for a garden hose. By replacing the existing spigot, the device of the invention achieves improvement over standard spigots and temporary extension devices by providing both a valve control handle 12 and an access pipe 14 that are distinctly elongated a significantly distal to the wall in the location of installation.

It is to be understood that while the invention is intended primarily for use with a garden hose, this is not intended as a limitation. The invention may be used with any device which is intended to be attached to an outdoor water spigot.

The invention is intended as a replacement for a standard outdoor spigot, for installation by a home repair or remodeling service, or by the homeowner. Alternate embodiments, intended for installation as original equipment during construction of the residence, are also contemplated.

The first exemplary embodiment is comprised of a horizontal pipe 11 having a first end 11A and a second end 11B. The second end 11B is affixed to the valve 16, which is controlled by the rotatably attached, enlarged circular handle 12. The handle 13 may be understood as enlarged relative to common handles and knobs, for example with a diameter of 4-6 inches. Threads 13 for attachment to a water supply pipe are located at the first end 11B of the horizontal pipe 11. The horizontal pipe may be elongated such that the handle 12 is positioned distal to the wall, for example by 6-8 inches, thus improving valve control and water access by users. A descending pipe 14 having an upper end 14B and a lower end 14A is provided which is preferably four to six inches in length (elongated so as to be distal to the handle 12 and to the wall where installed). The descending pipe is affixed to the valve 16 at its upper end 14B. The valve 16 is configured such that fluid communication may be selectively allowed between the horizontal pipe 11 and the descending pipe 14, depending upon the position of the handle 12. At the lower end 14A of the descending pipe 14, threads 13 are provided for attachment of a garden hose or other device (generically, a water device). The descending pipe 14 may be angled forward (relative to the horizontal pipe 11 and to the wall where installed) to provide greater clearance between the threads 13 and the wall. A shield 16 may optionally be affixed surrounding the second end 14B of the horizontal pipe 14.

To use the first exemplary embodiment, the user attaches a garden hose or other device to the threads 13 at the lower end of the descending pipe 14. The user may then turn the handle 12, which turns on the flow of water.

The horizontal pipe 11, the handle 12, and the descending pipe 14 are preferably manufactured from rigid, durable materials which are resistant to corrosion, such as steel or aluminum alloy. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An extending spigot replacement for an outdoor garden hose comprising a horizontal pipe; said horizontal pipe having a first end and a second end; said first end of said horizontal pipe being threaded; a valve; said second end of said horizontal pipe being affixed to said valve; a descending pipe; said descending pipe having an upper end and a lower end; said upper end of said descending pipe being affixed to said valve; said lower end of said descending pipe being threaded; a handle; said handle being rotatably attached to said valve; said valve being configured so as to selectively permit fluid communication between said horizontal pipe and said descending pipe based on the position of said handle.

2. The extending spigot replacement of claim 1 wherein said handle is circular and enlarged.

3. The extending spigot replacement of claim 1 wherein said horizontal pipe is elongated.

4. The extending spigot replacement of claim 2 wherein said horizontal pipe is elongated.

5. The extending spigot replacement of claim 1 wherein said descending pipe is elongated.

6. The extending spigot replacement of claim 2 wherein said descending pipe is elongated.

7. The extending spigot replacement of claim 3 wherein said descending pipe is elongated.

8. The extending spigot replacement of claim 4 wherein said descending pipe is elongated.

9. The extending spigot replacement of claim 1 wherein said descending pipe is angled forward.

10. The extending spigot replacement of claim 2 wherein said descending pipe is angled forward.

11. The extending spigot replacement of claim 3 wherein said descending pipe is angled forward.

12. The extending spigot replacement of claim 4 wherein said descending pipe is angled forward.

13. The extending spigot replacement of claim 5 wherein said descending pipe is angled forward.

14. The extending spigot replacement of claim 6 wherein said descending pipe is angled forward.

15. The extending spigot replacement of claim 7 wherein said descending pipe is angled forward.

16. The extending spigot replacement of claim 8 wherein said descending pipe is angled forward.

17. A method of using an extending spigot replacement for an outdoor garden hose, the spigot replacement comprising:
a horizontal pipe; said horizontal pipe having a first end and a second end; said first end of said horizontal pipe being threaded; a valve; said second end of said horizontal pipe being affixed to said valve; a descending pipe; said descending pipe having an upper end and a lower end; said upper end of said descending pipe being affixed to said valve; said lower end of said descending pipe being threaded; a handle; said handle being rotatably attached to said valve; said valve being configured so as to selectively permit fluid communication between said horizontal pipe and said descending pipe based on the position of said handle;
and the method comprising:
affixing said first end of said horizontal pipe to a compatibly threaded water supply pipe; affixing a compatibly threaded water device to said lower end of said descending pipe; and selectively permitting water from said water supply pipe to pass through said horizontal pipe, said valve, and said descending pipe into said compatibly threaded water device.

18. The method of using an extending spigot replacement for an outdoor garden hose of claim 17 wherein said handle is circular and enlarged; said horizontal pipe is elongated; said descending pipe is elongated; and descending pipe is angled forward.
